(19) United States
(12) Patent Application Publication
(10) Pub. No.: US 2013/0063991 A1
(43) Pub. Date: Mar. 14, 2013

(54) VOLTAGE CONVERTER CONFIGURATIONS FOR SOLAR ENERGY SYSTEM APPLICATIONS

(71) Applicants: Yuan Xiao, Kitchener (CA); Navid R. Zargari, Cambridge (CA); Zhongyuan Cheng, Cambridge (CA)

(72) Inventors: Yuan Xiao, Kitchener (CA); Navid R. Zargari, Cambridge (CA); Zhongyuan Cheng, Cambridge (CA)

(73) Assignee: Rockwell Automation Technologies, Inc., Mayfield Heights, OH (US)

(21) Appl. No.: 13/595,740

(22) Filed: Aug. 27, 2012

Related U.S. Application Data
(60) Provisional application No. 61/534,116, filed on Sep. 13, 2011.

(51) Int. Cl. H02M 7/48

(52) U.S. Cl. 363/71; 363/13

(57) ABSTRACT

A system includes a low switching frequency power converter configured to be coupled to a solar cell, wherein the low switching frequency power converter is configured to generate alternating current (AC) power based on low voltage direct current (DC) power transmitted from the solar cell and transmit the converted AC power. The system also include a multi-pulse transformer configured to receive the converted AC power and generate transformed power based on the converted AC power, wherein the transformed power comprises power at a voltage level that differs from the a voltage level of the converted AC power.

### CROSS-REFERENCE TO RELATED APPLICATIONS

This application claims the benefit of U.S. Provisional Patent Application No. 61/534,116, entitled “Medium Voltage Converter Configurations For Solar Energy System Applications,” filed Sep. 13, 2011, which is herein incorporated by reference.

### BACKGROUND

The subject matter disclosed herein generally relates to power conversion systems and, more particularly, to photovoltaic power conversion systems.

The demand for attractive and practical alternative renewable energy sources for generating electrical energy has continued to steadily increase due at least in part to rising environmental concerns, cost of fossil fuels, and/or various political initiatives. Currently, solar panels that include solar cells may be utilized for receiving and transforming solar energy (e.g., in the form of sunlight) into electricity that may be used to power buildings, as well as provide electricity to an electrical grid. However, the electrical power generated by these solar cells may not always be directly usable by a consumer and/or by a power grid. Accordingly, it would be advantageous to be able to convert the electricity generated by solar cells into power directly usable by consumers or transmittable along a voltage power grid.

### BRIEF DESCRIPTION

The present disclosure generally relates to photovoltaic power systems. In particular, various embodiments of the present disclosure provide for a photovoltaic power system for transforming low voltage outputs of solar cells into voltage outputs for use by a consumer or transmission to a power grid. A first system may include a silicon controlled rectifier that allows for the transformation of low voltage electricity generated by solar cells into, for example, medium voltage. Additionally, the present disclosure details a second system that may include a pulse width modulation current source inverter as part of the system to generate medium voltage from low voltage solar generated electricity. Another system may include a voltage source inverter with a transformer for generating medium voltage from low voltage solar generated electricity. Another technique may allow for the generation of medium voltage low voltage solar generated electricity without the use of a transformer; instead bridge circuitry may be utilized to generate multi-phase medium voltage from low voltage solar generated electricity. Furthermore, isolated direct current converters may be implemented to generate medium voltage from a low voltage solar electricity source. These techniques may allow for the generation of medium voltage that may be outputted to a medium voltage power grid from low voltage sources, such as solar cells.

### DRAWINGS

These and other features, aspects, and advantages of the present invention will become better understood when the following detailed description is read with reference to the accompanying drawings in which like characters represent like parts throughout the drawings, wherein:

FIG. 1 is a simplified block diagram of a first system for generating voltage, in accordance with an embodiment;

FIG. 2 is a simplified block diagram of a second system for generating voltage, in accordance with an embodiment;

FIG. 3 is a simplified block diagram of a third system for generating voltage, in accordance with an embodiment;

FIG. 4 is a simplified block diagram of a fourth system including an isolated direct current to direct current converter for generating voltage, in accordance with an embodiment;

FIG. 5 is a simplified block diagram of a fifth system including a second isolated direct current to direct current converter for generating voltage, in accordance with an embodiment; and

FIG. 6 is a simplified block diagram of a sixth system including a third isolated direct current to direct current converter for generating voltage, in accordance with an embodiment.

### DETAILED DESCRIPTION

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein to simplify explanation, the disclosure is intended to cover all combinations of these embodiments.

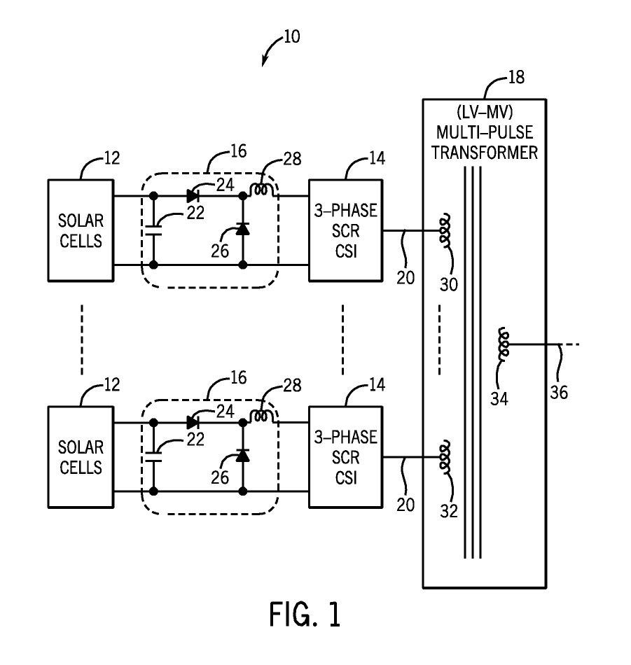

Referring first to FIG. 1, a block diagram of an embodiment of a photovoltaic (PV) power system 10 is illustrated, which may include a first aspect of the presently disclosed techniques. The PV power system 10 may include one or more solar cells 12. Each solar cell (e.g., photovoltaic cell) 12 represents an electrical device that converts the energy of light directly into electricity by the photovoltaic effect. These solar cells 12 may be formed, connected, and packaged into one or more solar panels, which may then be grouped into a solar panel array (e.g., a photovoltaic array) that may be utilized to harvest a greater amount of solar energy. However, this solar energy generated by the solar cells 12 may not be directly connectable to a typical power grid. For example, the electricity generated by the solar cells 12 may produce power with a voltage unacceptable for transmission onto a medium voltage grid or any other voltage grid level or any other voltage grid level. That is, the solar cells 12 may produce low voltage power of approximately 600-650 V (for example, when the solar cells 12 are coupled in series to generated the low voltage electricity of approximately 600-650 V), which may be too low for use in medium grid applications.

As such, the PV power system 10 may include additional elements to convert the low voltage power generated by the solar cells 12 to voltages usable and transmittable on a medium voltage (e.g., 1000 kV to 35000 kV) grid. In some embodiments, this medium voltage may be provided by, for example, low -voltage or medium-voltage AC drives such as the PowerFlex® drives from Rockwell Automation, Inc., to generate a voltage up to 35 kV AC. Additionally, to further allow for the power generated by the solar cells 12 to be usable by a medium voltage grid, the PV power system 10 may also include elements able to reduce harmonic distortion present in the power transmitted to the medium voltage power grid. A first embodiment of the PV power system 10 capable of producing this usable power from solar cells 12 for a medium voltage grid includes current source inverters 14 each corresponding to a set of solar cells 12 (e.g., each part of one or more panels), current generators 16, as well as a transformer 18. These current source inverters 14 may be, for example, 3-phase thyristor (e.g., silicon-controlled rectifier [SCR]) circuits.

The current source inverters 14 may operate to convert the direct current (DC) power generated by the solar cells 12 into alternating current (AC) power. In some embodiments, the current source inverters 14 may be specific control rectifier current source inverters 14, specifically three phase specific control rectifier current source inverters 14 capable of generating three phase AC power and transmitting this power (e.g., electricity) along path 20. Due to the use of a multi-pulse transformer (e.g., transformer 18), the three phase specific control rectifier current source inverters 14 may operate at low switching frequencies (e.g., ranging from approximately 50 Hz or 60 Hz to 1000 Hz or 2000 hz) to also aid in reduction of harmonic distortions. However the current source inverters 14 may not operate well with a voltage source, such as solar cells 12, providing the DC power to be converted into AC power. As such, the PV power system 10 may include current generators 16 disposed between the solar cells 12 and the current source inverters 14.

As illustrated, each solar cell 12 is coupled to a current generator 16, which is then coupled to a respective current source inverter 14. Each current generator 16 may include circuit features such as a capacitor 22, a chopper diode 24, a diode 26, and an inductor 28, for example, to stabilize a voltage and/or filter noise present in the power. It may be appreciated that more or fewer components may be utilized in the current generator 16 and that the components of the current generator 16 may be tuned as required by the solar cells 12 to which they are coupled. In one embodiment, the current generator 16 may receive low voltage DC power (e.g., 100-600 V) from the solar cells 12 acting as voltage power sources and transmit current, for example, at a fixed or varied voltage to the current source inverters 14. That is, the current generators 16 may operate as current sources for the current source inverters 14, effectively converting power transmitted from the solar cells 12 from a voltage source form to a current source form. Additionally, because the components of the current generators 16 are changeable (i.e., they can be tuned to chosen levels), control of the current source inverters 14 may be effected through modification of their respective current generators 16 to achieve desired outputs on path 20.

The power transmitted along path 20 is received by the transformer 18. The transformer 18 may be a step-up transformer that takes source voltage of a first voltage (e.g., 100-600 V, which can vary based on the number of solar cells 12 connected in series and can be selected to match the current source inverters 14/transformer 18 to a medium grid) and converts it to a higher voltage (e.g., medium voltage, for example, 2400 kV, 3300 kV, or another medium voltage value). To accomplish this, the transformer 18 may include primary windings 30 and 32 and at least one secondary winding 34. In one embodiment, the number of the turns of primary winding 30 is equivalent to the number of turns of primary winding 32; however, the numbers of turns in primary windings 30 and 32 may also differ, as necessitated by the PV power system 10. The ratio of windings in the secondary winding 34 to windings in the primary windings 30 and 32 determines the increase in voltage that the transformer will output on path 36. By using a multi-pulse transformer as the transformer 18, only low amounts of total harmonic distortion will be transmitted with the stepped-up power along path 36. Additionally, the overall cost of the PV power system 10 may be reduced through the use of specific control rectifier current source inverters 14. The PV power system 10 of FIG. 1 also allows for high efficiency, since the components of PV power system 10 (e.g., specific control rectifier current source inverters 14 and multi-pulse transformer 18) tend to be low switching loss components. Finally, the PV power system 10 is set up such that there is low voltage stress on the solar cells 12, which may allow for increased lifespan of the solar cells 12.

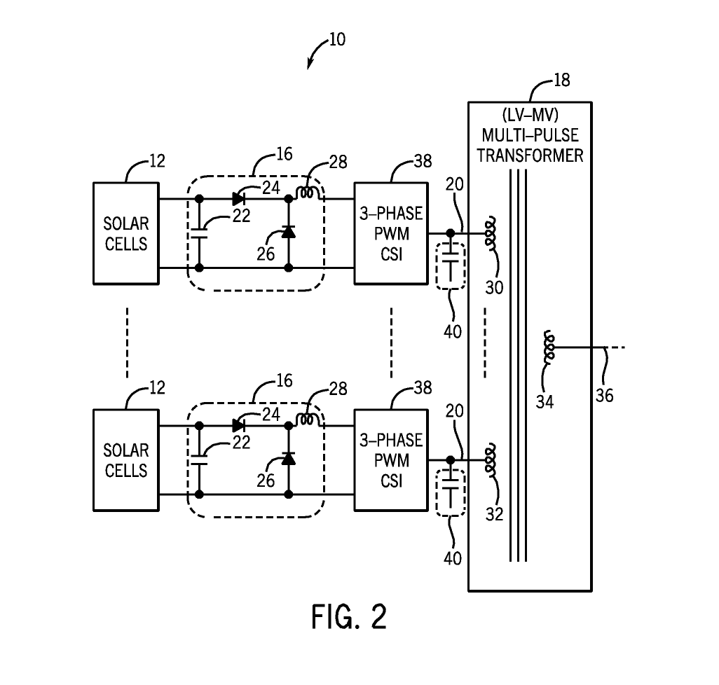

However, in other embodiments, the PV power system 10 may include different components from those described above with respect to FIG. 1. For example, FIG. 2 illustrates the PV power system 10 with different features. PV power system 10 of FIG. 2 includes solar cells 12, current generators 16, paths 20, a multi-pulse transformer as the transformer 18, and path 36 similar to those illustrated and discussed above with respect to FIG. 1. However, in the place of specific control rectifier current source inverters 14 of FIG. 1, the embodiment of FIG. 2 may utilize pulse width modulation current source inverters 38, specifically three phase pulse width modulation current source inverters 38. These pulse width modulation current source inverters 38 may allow, for example, for greater control of the output transmitted along path 20 relative to the system of FIG. 1. Additionally, the pulse width modulation current source inverters 38 may operate at a relatively low inverter switching frequency. Additionally, in some embodiments, a filter 40 may be utilized in conjunction with the pulse width modulation current source inverters 38 to allow for filtering of the power transmitted along path 20. This filter 40 may allow for an increased power factor to be attainable by the PV power system 10. Moreover, because the components of the current generators 16 and filters 40 may be initially determined based on use (i.e., they can be tuned to chosen levels), control of the current source inverters 38 may be effected through modification of their respective current generators 16 and filters 40 to achieve desired outputs on path 20.

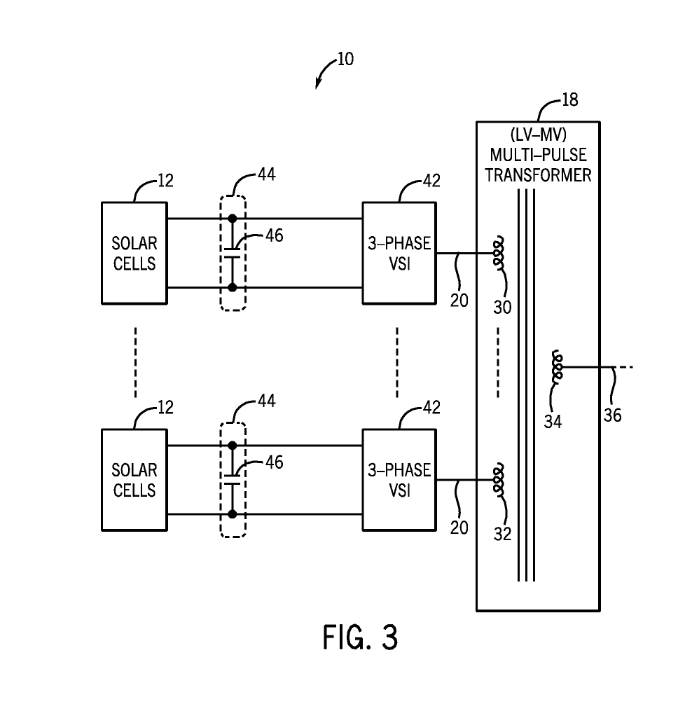

The PV power systems 10 in FIGS. 1 and 2 utilize current source technologies. However, in some embodiments, it may be desirable to reduce components utilized in the PV power system (e.g., to reduce the overall size and/or complexity of the PV power system 10). FIG. 3 illustrates an embodiment of the PV power system 10 that operates without the use of a current source. PV power system 10 of FIG. 3 includes solar cells 12, current generators 16, paths 20, a multi-pulse transformer as the transformer 18, and path 36 similar to those illustrated and discussed above with respect to FIGS. 1 and 2. However, in the place of current source inverters 14 and 38 of FIGS. 1 and 2, the PV power system 10 of FIG. 3 may utilize three phase voltage source inverters 42 to convert the received DC power generated by the solar cells 12 into AC power. In some embodiments, a stabilizer circuit 44 including a capacitor 46 with a capacitance value chosen based on the application, may be utilized to stabilize the power received from the solar cells 12. This power may then be transformed into AC power by the three phase voltage source inverters 42. The three phase voltage source inverters 42 may operate at low switching frequencies to also aid in reduction of distortions, such as harmonic distortions.

In this manner, the three phase voltage source inverters 42 may directly operate on the power generated by the solar cells 12 (i.e., directly operate on power from a voltage source rather than a current source), thus reducing potential overhead associated with the PV power systems 10 discussed in conjunction with FIGS. 1 and 2. Moreover, advantages of the PV power system 10 of FIG. 3 include transmission of only low amounts of total harmonic distortion with the stepped-up power transmitted along path 36. Additionally, the overall size and complexity of the PV power system 10 may be reduced through the use of the three phase voltage source inverters 42. The PV power system 10 of FIG. 3 also allows for high efficiency, since the components of PV power system 10 (e.g., three phase voltage source inverters 42 and multi-pulse transformer 18) tend to be low switching loss components. Finally, the PV power system 10 is set up such that there is low voltage stress on the solar cells 12, which may allow for increased lifespan of the solar cell elements.

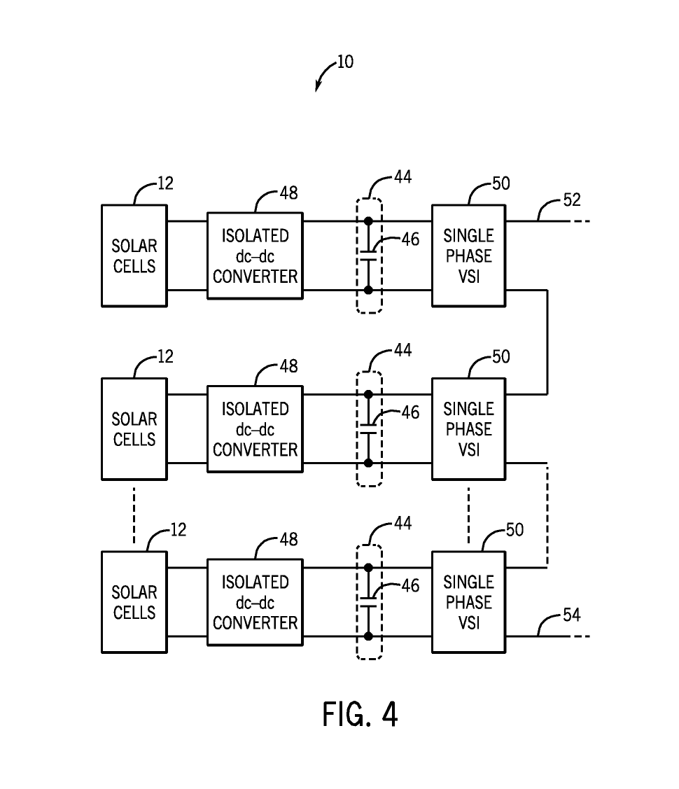

FIG. 4 illustrates another embodiment of the PV power system 10. The PV power system 10 includes no multi-pulse transformer 18. Instead, in FIG. 4, PV power system 10 includes an H-bridge circuit configuration with isolated DC-DC converters. For example, PV power system 10 of FIG. 4 includes solar cells 12 similar to those discussed above with respect to FIGS. 1-3 as well stabilizer circuits 44 similar to those discussed above with respect to FIG. 3. The PV power system 10 may also include DC-DC converters 48 each coupled to a respective stabilizer circuit 44 and a respective single phase voltage source inverters 50, which may convert received DC power generated by the solar cells 12 into AC power.

The DC-DC converters 48 may be isolated DC-DC-converters 48, which operate as electronic circuits that convert DC power from one voltage level to another. These isolated DC-DC-converters 48 may be utilized to match voltages from their respective solar cells 12, to provide, for example, isolation from the low voltage and medium voltage portions of the PV power system 10. The voltage produced in the isolated DC-DC-converters 48 may be transmitted to the single phase voltage source inverters 50 for generation of AC power from the received DC power.

In one embodiment, the single phase voltage source inverters 50 may be coupled to one another in series. Thus, the power generated by the set of single phase voltage source inverters 50 may be summed to generate a single phase of medium voltage power on path 52. So that the medium voltage grid receives three phase power, it is envisioned that three of the PV power systems 10 of FIG. 4 could be utilized in conjunction with one another, each with an output path 52 providing one phase of power to the medium voltage grid and each with neutral path 54 coupled to one another to provide a common neutral signal along path 54. In this manner, converted power from solar cells could be provided to a medium voltage grid without the use of a transformer 18 such as multi-pulse transformer 18.

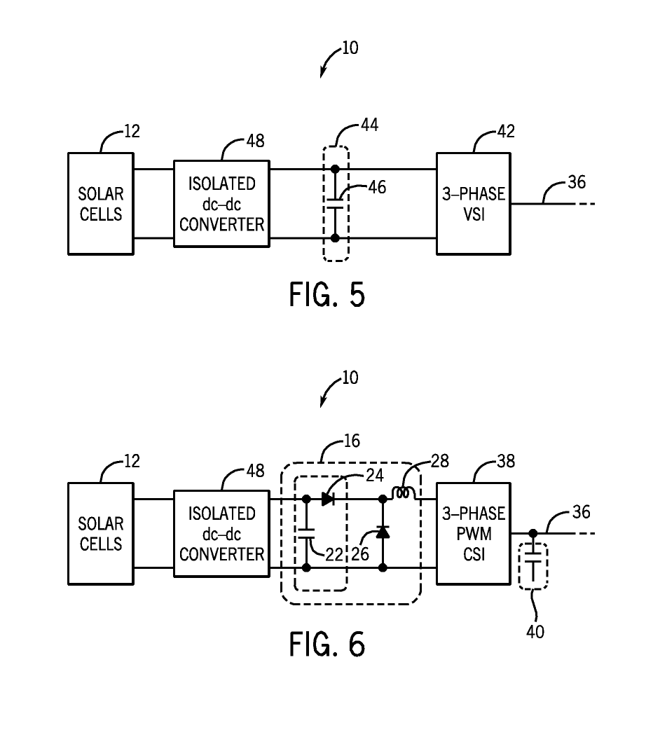

Continuing to FIG. 5, another embodiment of the PV power system 10 is illustrated. The embodiment in FIG. 5 is capable of performing a second technique for generating medium voltage power from solar cells 12 without the use of a transformer 18, such as a multi-pulse transformer 18. The PV power system 10 of FIG. 5 includes solar cells 12 similar to those discussed above with respect to FIGS. 1-4, path 36 similar to that discussed above with respect to FIGS. 1-3, a three phase voltage source inverter 42 and a stabilizer circuit 44 similar to those discussed above with respect to FIG. 3, and an isolated DC-DC converter 48 similar to those discussed above with respect to FIG. 4.

In operation, the solar cells 12 of PV power system 10 of FIG. 5 may provide low voltage power to the isolated DC-DC power converter 48. The isolated DC-DC power converter 48 may generate a medium DC voltage from the low voltage power supplied thereto and may pass this medium DC voltage to a stabilizer circuit 44 for eventual transmission to the three phase voltage source inverter 42. The three phase voltage source inverter 42 may operate to generate three phase medium voltage AC power from the received medium DC voltage and may transmit the three phase medium voltage AC power to path 36 for transmission to a medium voltage grid. In this manner, a simple and easily implemented voltage source driven conversion of low voltage power from solar cells 12 to medium voltage power may be accomplished.

FIG. 6 illustrates a further embodiment of the PV power system 10. The embodiment in FIG. 6 is capable of performing a third technique for generating medium voltage power from solar cells 12 without the use of a transformer 18, such as a multi-pulse transformer 18. The PV power system 10 of FIG. 6 includes solar cells 12 similar to those discussed above with respect to FIGS. 1-5, current generator 16 similar to that discussed above with respect to FIGS. 1 and 2 (albeit with the capacitor 22 and chopper diode 24 being omitted in some embodiments from the current generator 16), path 36 similar to that discussed above with respect to FIGS. 1-3 and 5, a three phase pulse width modulation current source inverter 38 and a filter 40 similar to those discussed above with respect to FIG. 2, and an isolated DC-DC converter 48 similar to those discussed above with respect to FIGS. 4 and 5.

In operation, the solar cells 12 of PV power system 10 of FIG. 6 may provide low voltage power to the isolated DC-DC power converter 48. The isolated DC-DC power converter 48 may generate a medium DC voltage from the low voltage power supplied thereto and may pass this medium DC voltage to the current generator 16, so that a current source may be provided to the three phase pulse width modulation current source inverter 38 (e.g., for proper operation of the three phase pulse width modulation current source inverter 38). The three phase pulse width modulation current source inverter 38 may operate to generate three phase medium voltage AC power from the received power transmitted from the current source (e.g., current generator 16) and may transmit the three phase medium voltage AC power to path 36 for transmission to a medium voltage grid. In this manner, a simple and easily implemented current source driven conversion of low voltage power from solar cells 12 to medium voltage power may be accomplished.

While only certain features of the invention have been illustrated and described herein, many modifications and changes will occur to those skilled in the art. It is, therefore, to be understood that the appended claims are intended to cover all such modifications and changes as fall within the spirit and scope of this disclosure.

1. A system comprising:
a low switching frequency power converter configured to be coupled to a solar cell, wherein the low switching frequency power converter is configured to:
generate converted alternating current (AC) power based on low voltage direct current (DC) power transmitted from the solar cell; and
transmit the converted AC power; and
a multi-pulse transformer configured to receive the converted AC power and generate transformed power based on the converted AC power, wherein the transformed power comprises power at a voltage level that differs from a voltage level of the converted AC power.

2. The system of claim 1, comprising a plurality of low switching frequency power converters each configured to be coupled to a one of a plurality of solar cells and configured to generate respective AC converted power, wherein the respective AC converted power is combined in series with the converted AC power to generate combined converted AC power, wherein the multi-pulse transformer is configured to generate the transformed power based on the combined converted AC power.

3. The system of claim 1, wherein the transformed power comprises power at a voltage of at least several times the value of a voltage of the low voltage DC power transmitted from the solar cell.

4. The system of claim 1, wherein the low switching frequency power converter comprises a current source inverter.

5. The system of claim 4, wherein the current source inverter comprises a three phase specific control rectifier current source inverter.

6. The system of claim 4, wherein the current source inverter comprises a three phase pulse width modulation current source inverter.

7. The system of claim 4, comprising a current generator configured to operate as a current source for the current source inverter.

8. The system of claim 7, wherein the current generator is configured to utilize the low voltage DC power transmitted from the solar cell as input power for the current generator.

9. The system of claim 1, wherein the low switching frequency power converter comprises a voltage source inverter.

10. The system of claim 9, comprising a stabilizer circuit configured to stabilize the low voltage DC power transmitted from the solar cell and transmit the stabilized power low voltage DC power to the voltage source inverter.

11. The system of claim 1, wherein the low switching frequency power converter operates at a maximum frequency of approximately 50 Hz to 60 Hz.

12. The system of claim 1, wherein the transformed power comprises power at a voltage up to 35,000 V.

13. A system comprising:
a power converter configured to be coupled to a solar cell, wherein the power converter is configured to generate converted direct current (DC) voltage based on low voltage DC power transmitted from the solar cell; and
a conversion circuit configured to generate AC power based on the converted DC voltage, wherein the converted DC voltage comprises a voltage level that differs from the voltage level of the low voltage DC power.

14. The system of claim 13, wherein the conversion circuit is configured to add additional AC power to the AC power.

15. The system of claim 14, wherein the conversion circuit comprises a single phase voltage source inverter.

16. The system of claim 13, wherein the conversion circuit comprises a three phase voltage source inverter.

17. The system of claim 13, wherein the conversion circuit comprises a three phase specific control current source inverter.

18. The system of claim 17, comprising a current generator configured to operate as a current source for the three phase specific control current source inverter.

19. The system of claim 18, wherein the current generator is configured to utilize the converted DC voltage transmitted from power converter as an input for the current generator.

20. The system of claim 13, wherein the converted DC voltage comprises power at a voltage no greater than 35,000 V.

21. A method comprising:
generating converted alternating current (AC) power in a low switching frequency power converter based on a low voltage direct current (DC) power transmitted from a solar cell;
transmitting the converted AC power from the low switching frequency power converter;
receiving the converted AC power at a multi-pulse transformer; and
generating transformed power in the multi-pulse transformer based on the received converted AC power, wherein the transformed power comprises AC power at a voltage different from a voltage of the low voltage DC power.

22. The method claim 21, comprising operating the low switching frequency power converter at a switching frequency under 2000 Hz.
